(19) United States
(12) Patent Application Publication
(10) Pub. No.: US 2019/0208772 A1
(43) Pub. Date: Jul. 11, 2019

(54) Wildlife solid scents

(71) Applicant: Charles Kay Christian, Milton, FL (US)

(72) Inventor: Charles Kay Christian, Milton, FL (US)

(21) Appl. No.: 15/712,128

(22) Filed: Sep. 21, 2017

Related U.S. Application Data
(60) Provisional application No. 62/495,695, filed on Sep. 22, 2016.

(51) Int. Cl. A01N 25/08

(52) U.S. Cl. CPC A01N 25/08

(57) ABSTRACT

This is a way to attract game animals into a desired location. Quick activating with a slow release of scent. It is easy to deploy. Exceptionally long-lasting and environmentally safe.

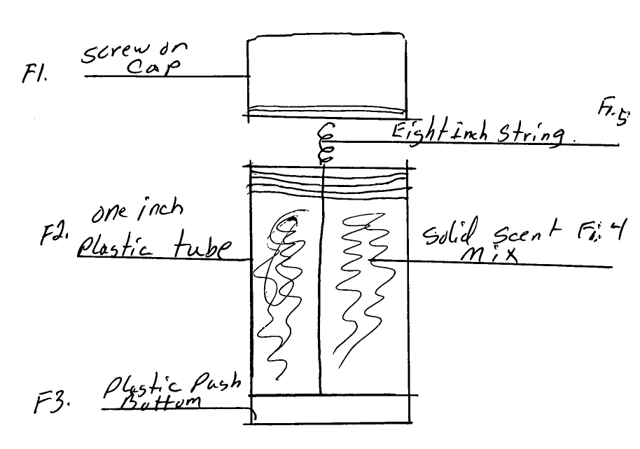

### BRIEF SUMMARY OF INVENTION

This is a solid form of scent not a liquid or gel. It is long lasting, so there is no need to retreat frequently. The possibility of human scent contamination is greatly decreased. It is easy to use. In using with invention the chance of compromised scent is eliminated. It will not evaporate like liquid or gel products that are currently being used.

### BACKGROUND OF INVENTION

Hunters employ many techniques to lure game animals into their hunting area. One is the use of liquid scent of the animal they pursue. EXAMPLE [Doe in estrus]. Although the methods do work. They require that they be retreated every so often. Because the scent has evaporated or simply been compromised by something. In doing this the chance of human scent contamination is greatly increased. But with this invention the need to retreat less often thus decreasing the chance of human scent contamination.

### BRIEF SUMMARY OF INVENTION

This is a solid form of scent not a liquid or gel. It is long lasting, so there is no need to retreat frequently. The possibility of human scent contamination is greatly decreased. It is easy to use. In using with invention the chance of compromised scent is eliminated. It will not evaporate like liquid or gel products that are currently being used.

### DESCRIPTION

This product is used to attract wildlife to bring them closer to a hunter. The product is plant glycerin mixed at a 2 to 1 ratio, with the desired scent.

Example (Doe in Estrus).

The plant glycerin is melted to a liquid form and then mixed with the desired scent, and allowed to cool and hardened in a one ounce push-up container with a string in the center of it, to allow a hunter to hang it in place of choice. The delivery system allows a long-term slow release of scent.

### DETAILED DESCRIPTION OF THE INVENTION

How It's Made:

This is a mixture of plant glycerin and the desired scent.

Example [Doe in estrus] at a 2 to 1 ratio. Two part glycerin and one part scent.

The glycerin will liquefy at approximately 120 F. Let cool to 100 F and add scent to mixture and stir. At this time it can be poured into the 1 oz plastic [push-up from the bottom] tubs with the 8 in sting provided. Let cool until it returns to a solid form. Coil is string under the cap provided for the tube. This invention is a solid form not a liquid or a gel or a spray form of attractant.

How to Use It:

This product is simple to use. Simply remove the cap on the plastic tube. Pull the string out take your thumb and push the plastic center up the tube on the bottom of the tube up. The product will move up the tube. Where it can be removed and tied to a tree limb or bush for example. I recommend hanging it a eye level. This will help the wind to carry the scent faster. The liquid, gel, and spray products rely on the sun a lot of heat them up enough to rise up to be carried by the wind. This product only needs a little sunlight to activate it. There are other products that can be hung, but they also have to be retreated often to stay fresh. Most of these products evaporate in a matter of hours. Some of them are subject to temperature changes. Such as cold weather, drip systems can freeze up and stop working period. This product when the plastic tube and cap is properly disposed of is biodegradable and ECO friendly. It will be gone in about a year. The components that this product is made of are already in nature, so it is eco-friendly. In closing this product is safe and easy to use. It can last up to a month, but I recommend replacing it every two weeks.

### BRIEF DESCRIPTION OF DRAWING

This FIGURE shows a scent delivery system.

1. Solid scent
Description: this process creates an easy to use hassle free hang able solid scent.

2. Biodegradable ECO friendly
Completely dependable in approximately 1 year. All ingredients are environmentally save, since they already exist in nature.

3. Portable
Can be moved to a different location at hunter's discretion
